(19) United States
(12) Patent Application Publication
(10) Pub. No.: US 2013/0120990 A1
(43) Pub. Date: May 16, 2013

(54) LED LIGHT BULB STRUCTURE

(71) Applicants: CHIH-HSIEN WU, NEW TAIPEI CITY (TW); WEI CHANG, NEW TAIPEI CITY (TW); HUAN-YING LU, NEW TAIPEI CITY (TW); SHIH-CHAO SHEN, NEW TAIPEI CITY (TW)

(72) Inventors: CHIH-HSIEN WU, NEW TAIPEI CITY (TW); WEI CHANG, NEW TAIPEI CITY (TW); HUAN-YING LU, NEW TAIPEI CITY (TW); SHIH-CHAO SHEN, NEW TAIPEI CITY (TW)

(73) Assignee: UNITY OPTO TECHNOLOGY CO., LTD., NEW TAIPEI CITY (TW)

(21) Appl. No.: 13/414,863

(22) Filed: Mar. 8, 2012

(30) Foreign Application Priority Data
Nov. 15, 2011 (TW) 100221519

(51) Int. Cl. F21V 29/00; F21V 5/04

(52) U.S. Cl. 362/244

(57) ABSTRACT

An LED light bulb structure includes a lamp cover and a lamp holder engaged with one another to form a light source accommodating space, and the lamp holder has a circuit board, and at least three first LEDs installed in the light source accommodating space and electrically coupled to the circuit board. Each first LED has a light source portion and a plurality of pins, and an end of the pins is coupled to the light source portion, and the other end of the pins is electrically coupled to the circuit board, and each light source portion has a lens and a chip, and the lens covers the chip, and the chip irradiates a light beam in a horizontal direction, and the first LEDs are installed sequentially next to one another, such that the light source portions are arranged into a circle to form an installation space.

### CROSS-REFERENCE TO RELATED APPLICATIONS

This non-provisional application claims priority under 35 U.S.C. §119(a) on Patent Application No(s). 100221519 filed in Taiwan. R.O.C. on Nov. 15, 2011, the entire contents of which are hereby incorporated by reference.

### BACKGROUND OF THE INVENTION

1. Field of the Invention

The present invention relates to the technical field of non-portable illumination device, in particular to a light emitting diode (LED) light bulb structure having a plurality of side view LEDs connected sequentially next to one another and arranged in a circle to expand the illumination range.

2. Description of the Related Art

As the light emitting diodes (LED) with the advantages of a small volume, a low power consumption, a long service life, and a high light emitting efficiency, they are used extensively in daily illumination such as an LED light bulb or an advertising billboard. However, the beam angle of the LED falls within a range of 120 degrees to 140 degrees only, so that the illumination range of the LED is limited. To satisfy market requirements, most of the present existing LED light bulbs combine a plurality of LEDs to achieve the effect of expanding the illumination range. For example, both R.O.C. Pat. No. M364166 and U.S. Pat. No. 598,581 disclosed a plurality of LEDs arranged in a circular shape to form an LED light bulb with a cake-structure design, and the circular layered arrangement can enhance the illumination range and the brightness of the LEDs.

With reference to FIG. 1 for a schematic view of a cake-shaped LED light bulb disclosed in R.O.C. Pat. No. M364166, the cake-shaped LED light bulb 1 comprises a plurality of top view LEDs 10 arranged around a circuit board to form a first circular layer 101, and then placed on a substrate 11 at the middle of the circuit board, and the LEDs 10 are further arranged to form a second circular layer 102, and then the LED 10 with high pins are installed at a central position of the second circular layer 102 to form an upwardly extended third circular layer 103. With the circular layers 101, 102, 103, the cake-shaped LED light bulb 1 can produce a change of multi-layer light sources to enhance the illumination intensity and illumination range. However, the aforementioned prior arts adopt the top view LED 10 stacked on one another, such that the light bulb 1 has an irradiating direction towards the front, and the beam angle of the light bulb 1 is limited. In addition, the LEDs 10 are attached onto the circuit board directly, so that the heat produced by the LEDs 10 are concentrated, and related components may be overheated or burned to cause an abnormal operation.

### SUMMARY OF THE INVENTION

In view of the shortcomings of the prior art, it is a primary objective of the present invention to overcome the problems of the prior art by providing an LED light bulb structure having a plurality of side view LEDs installed sequentially next to one another and arranged into a circle to achieve the effect of expanding the beam angle of the LED light bulb structure.

To achieve the aforementioned objective, the present invention provides an LED light bulb structure, comprising: a lamp cover and a lamp holder, and the lamp cover and the lamp holder being coupled to form a light source accommodating space, and the lamp holder having a circuit board installed thereon, and at least three first LEDs installed in the light source accommodating space and electrically coupled to the circuit board, characterized in that each first LED includes a light source portion and a plurality of pins, and an end of the pins is coupled to the light source portion, and the other ends of the pins is electrically coupled to the circuit board, and each light source portion has a lens and a chip, and the lens covers the chip, and the chip irradiates a light beam in a horizontal direction, and the first LEDs are installed sequentially next to one another, and the light source portions are arranged in a circle to form an installation space.

Wherein, each first LED is a side view LED, and the chip is installed onto one of the pins and covered into the lens of a hemispherical column or a sheet cube structure, such that each light source portion has an irradiating direction towards a side of the first LED. In addition. the first LED includes three pins, and one of the pins is electrically coupled to the other two pins, for carrying the chip to dissipate the heat released from the chip.

It is a secondary objective of the present invention to achieve the all-around light emitting effect, wherein the light source portions are arranged parallel to an axis of the LED light bulb structure, and the light source portions are arranged into a circle to form a substantially triangular or quadrilateral prism structure.

Another objective of the present invention is to further increase the illumination angle to 720 degrees, wherein the light source portions are set with an acute angle θ with respect to an axis of the LED light bulb structure, and if the acute angle θ increases progressively, the light source portions tend to have an irradiating direction towards the top of the lamp cover progressively. Further, the light source portions are set with an acute angle θ with respect to an axis of the LED light bulb structure, and if the acute angle θ of a portion of the light source portions increases progressively, the portion of the light source portions tend to have an irradiating direction towards the top of the lamp cover progressively, and if the acute angle θ of the other portion of the light source portions increases progressively, the other portion of the light source portions have an irradiating direction towards the lamp holder progressively.

A further objective of the present invention is to enhance the illumination intensity at the top of the lamp cover, wherein the LED light bulb structure further comprises at least one second LED installed in the installation space and electrically coupled to the circuit board, and the second LED is a top view LED having an irradiating direction towards the top of the lamp cover.

### BRIEF DESCRIPTION OF THE DRAWINGS

FIG. 1 is a schematic view of a cake-shaped LED light bulb disclosed in R.O.C. Pat. No. M364166;

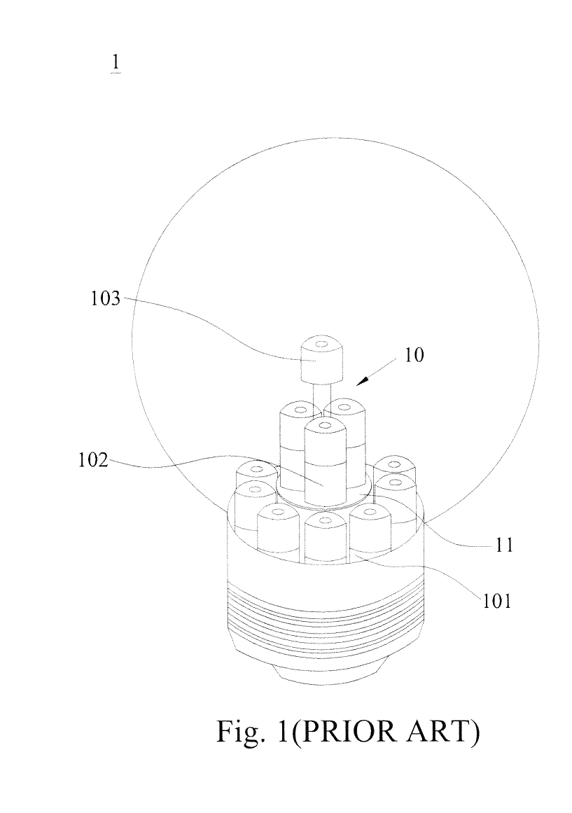

FIG. 2 is a schematic view of a first preferred embodiment of the present invention;

FIG. 3 is a schematic view of a second preferred embodiment of the present invention:

FIG. 4 is a schematic view of a third preferred embodiment of the present invention;

FIG. 5 is a schematic view of a fourth preferred embodiment of the present invention;

FIG. 6 is a schematic view of a fifth preferred embodiment of the present invention; and

FIG. 7 is a schematic view of a sixth preferred embodiment of the present invention.

### DETAILED DESCRIPTION OF THE PREFERRED EMBODIMENTS

The technical content of the present invention will become apparent with the detailed description of the following embodiments accompanied with the illustration of related drawings as follows.

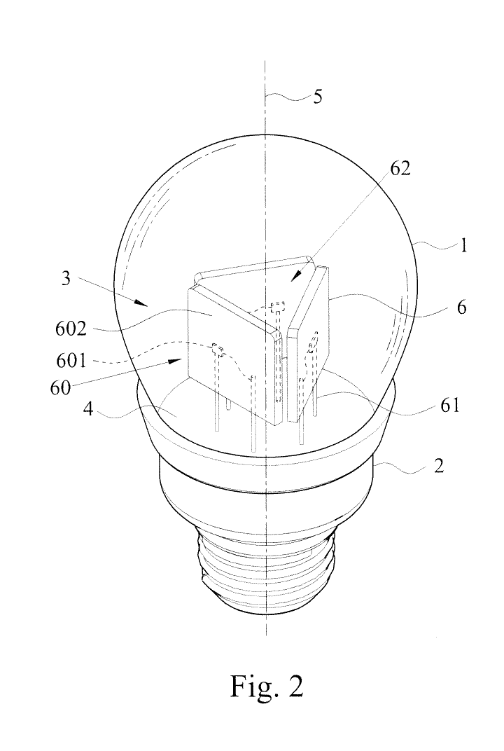

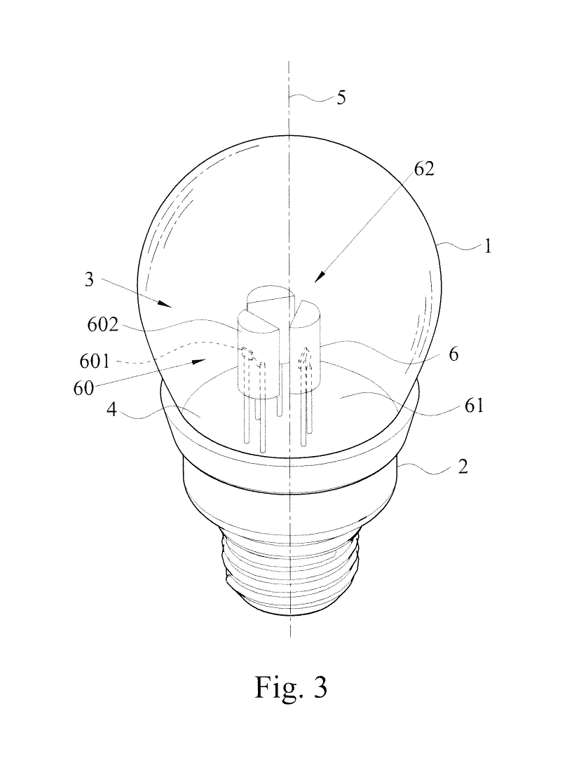

With reference to FIGS. 2 and 3 for schematic views of the first and second preferred embodiments of the present invention respectively, an LED light bulb structure comprises a lamp cover 1 and a lamp holder 2. and the lamp cover 1 and the lamp holder 2 are engaged with one another to form a light source accommodating space 3. The lamp holder 2 includes a circuit board 4 installed thereon, and at least three first LEDs 6 installed in the light source accommodating space 3 and electrically coupled to the circuit board 4. Each first LED 6 includes a light source portion 60 and a plurality of pins 61, and an end of the pins 61 is coupled to the light source portion 60, and the other end of the pins 61 is electrically coupled to the circuit board 4. Each light source portion 60 has a chip 601 and a lens 602, and the lens 602 is substantially a hemispherical column or a sheet cube structure for covering the chip 601, and the chip 601 is installed on one of the pins 61 for irradiating a light beam in a horizontal direction, such that each light source portion 60 has an irradiating direction towards a distal end of the first LED 6. The first LEDs 6 are side view LEDs, and the first LEDs 6 are installed sequentially next to each other, so that the light source portions 60 are arranged in a circle to form an installation space 62.

In this preferred embodiment, three first LEDs 6 are used. The first LEDs 6 are electrically coupled to the circuit board 4 through each pin 61, and each light source portion 60 of a hemispherical column structure or a sheet cube structure is parallel to an axis 5 of the LED light bulb structure, and the light source portions 60 are arranged sequentially next to one another, so that an angle exists between the light source portions 60. For example, the light source portions 60 are arranged with an angle of 60 degrees to form a substantially triangular prism structure, so that the light source portions 60 has irradiating directions towards three different positions at the distal end of the lamp cover 1. In other words, the difference of the angles between three different positions is equal to 120 degrees. Therefore, each light source portion 60 has a beam angle approximately equal to 120 degrees. The triangular prism structure can have an all-around light emitting range covering 360 degrees.

Since the light source portions 60 can be electrically coupled to the circuit board 4 through the pins 61, therefore a gap exists between each light source portion 60 and the circuit board 4, and the heat generated by the operation of each light source portion 60 will not be concentrated at the circuit board 4, and the heat can be dissipated quickly through the gap and the installation space 62 to improve the heat dissipation efficiency.

It is noteworthy to point out that the chips 601 can be a chip of white light, yellow light, blue light, green light or red light, so that the LED light bulb structure can have plentiful color changes. If the LED light bulb structure has two pins 61, the chip 601 installed on one of the pins 61 is coupled to a negative electrode, while a metal conductive wire connected to the other pin 61 is coupled to a positive electrode.

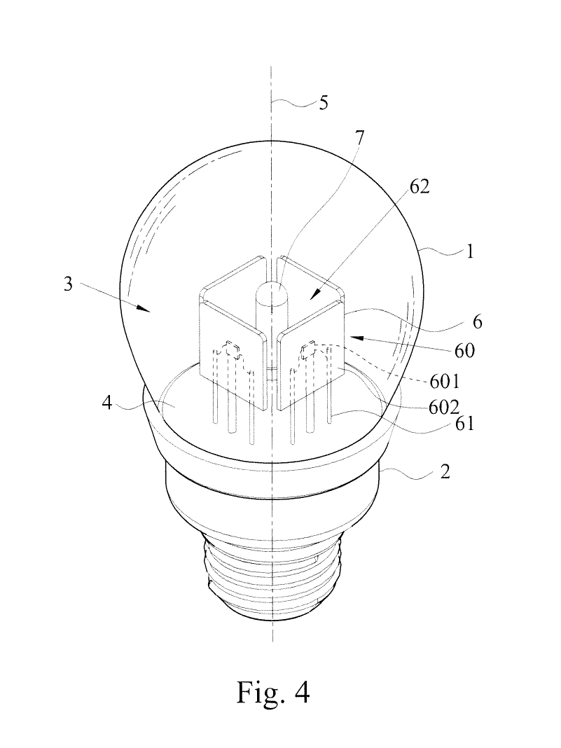

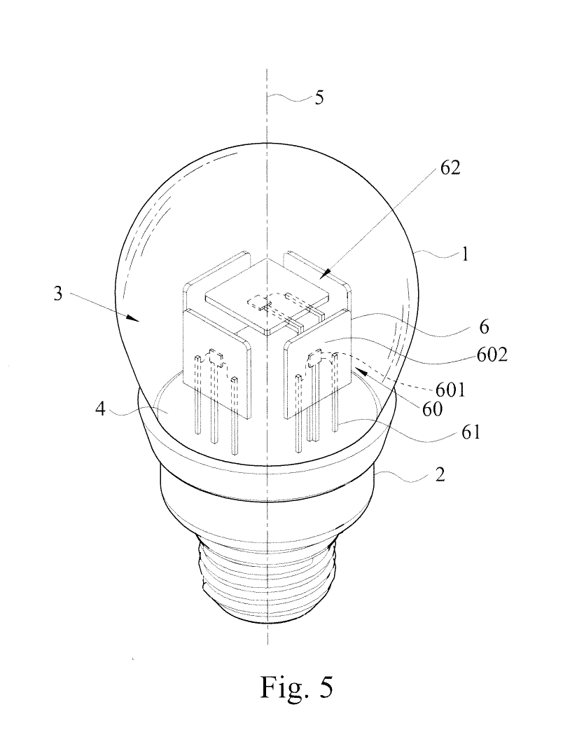

With reference to FIGS. 4 and 5 for schematic views of the third and fourth preferred embodiments of the present invention respectively, the LED light bulb structure can use four first LEDs 6, wherein each light source portion 60 of a hemispherical column or a sheet cube structure is parallel to an axis 5 of the LED light bulb structure, and the light source portions 60 are arranged sequentially next to one another. In the meantime, an angle exists between the light source portions 60. For example, an angle of 90 degrees can form a quadrilateral prism structure. Four different irradiating directions of the quadrilateral prism structure can achieve the all-around light emitting effect and provide an illumination intensity higher than that of the triangular prism structure.

Further, at least one second LED 7 can be installed inside the quadrilateral prism structure (or in the installation space 62) to enhance the beam angle and illumination range of the LED light bulb structure. The second LED 7 is a top view LED. Alternatively, the pins 61 can be bent directly to guide the irradiating direction of the light source portion 60 towards the top of the lamp cover 1, and the side view first LED 6 can be installed in the installation space 62.

It is noteworthy to point out that the first LEDs 6 can have three pins 61, and one of the pins 61 is provided for carrying the chip 601 and a metal conductive wire is provided for connecting the other two pins 61 to couple to positive and negative electrodes, so that the chip 601 can dissipate the heat through the connected pins 61 to speed the heat dissipation and improve the heat dissipation efficiency.

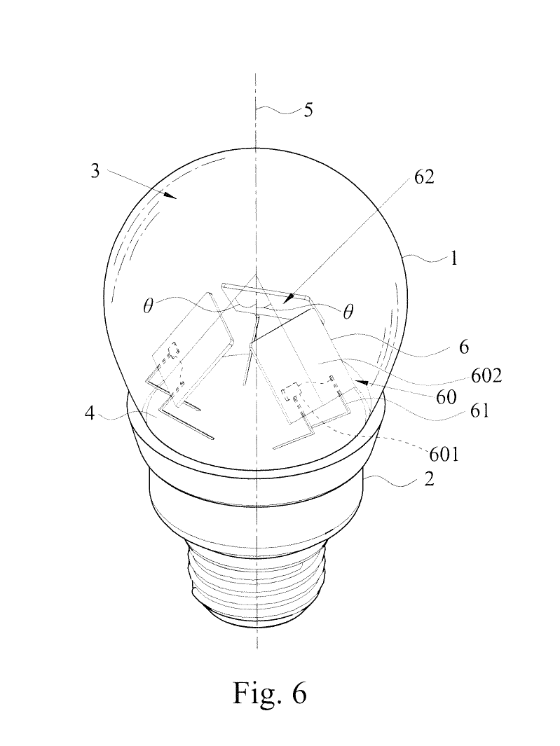

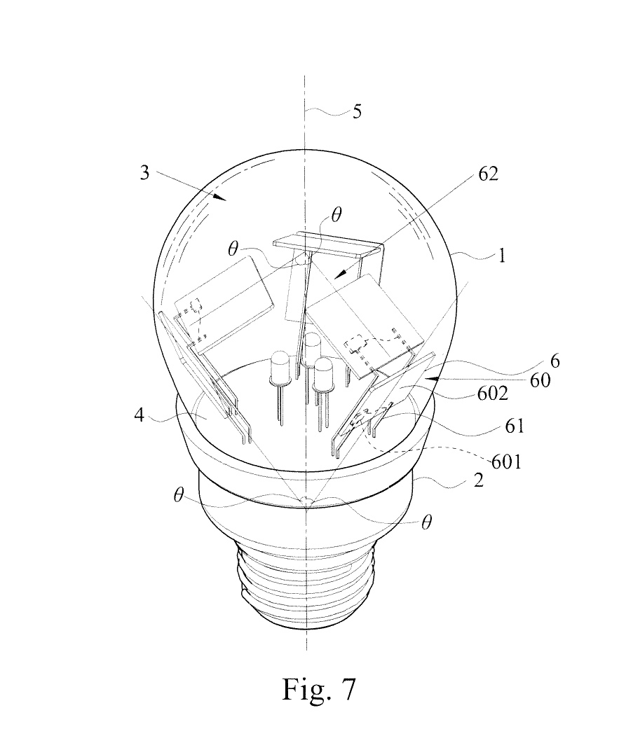

With reference to FIGS. 6 and 7 for schematic views of the fifth and sixth preferred embodiments of the present invention respectively, the LED light bulb structure can use the bent pins 61 of the three first LEDs 6 and the each light source portion 60 of a hemispherical column or a sheet cube structure having an acute angle θ with respect to an axis 5 of the LED light bulb structure to flexibly adjust the irradiating intensity at the front of the lamp cover 1. If the acute angle θ increases progressively, the irradiating direction of the light source portions 60 tends to be irradiated towards the top of the lamp cover 1 progressively.

To expand the irradiating angle in order to achieve an illumination range of 720 degrees, the LED light bulb structure can add three first LEDs 6 with an irradiating direction towards the lamp holder 2. Similarly, each pin 61 of the first LEDs 6 can be bent, such that each light source portion 60 has an acute angle θ with respect to an axis 5 of the LED light bulb structure. If the acute angle θ increases progressively, the irradiating direction of the light source portions 60 tends to be irradiated towards the lamp holder 1 progressively.

The second LEDs 7 still can be installed in the installation space 62 to enhance the illumination intensity.

In summation of the description above, the first LEDs 6 can be arranged into a circle or the pins 61 can be bent to expand the illumination range and illumination intensity of the LED light bulb structure of the present invention, and the first LEDs 6 can be arranged directly on the circuit board 4 of the LED light bulb structure, so as to achieve the effects of simplifying the manufacturing procedure, reducing the use of components, improving the production efficiency, and lowering the cost.

What is claimed is:

1. An LED light bulb structure, comprising a lamp cover and a lamp holder, and the lamp cover and the lamp holder being coupled to form a light source accommodating space, and the lamp holder having a circuit board installed thereon, and at least three first LEDs installed in the light source accommodating space and electrically coupled to the circuit board, characterized in that each first LED includes a light source portion and a plurality of pins, and an end of the pins is coupled to the light source portion, and the other ends of the pins is electrically coupled to the circuit board, and each light source portion has a lens and a chip, and the lens covers the chip, and the chip irradiates a light beam in a horizontal direction, and the first LEDs are installed sequentially next to one another, and the light source portions are arranged in a circle to form an installation space.

2. The LED light bulb structure of claim I, wherein each first LED is a side view LED, and the chip is installed onto one of the pins and covered into the lens of a hemispherical column or a sheet cube structure, such that each light source portion has an irradiating direction towards a side of the first LED.

3. The LED light bulb structure of claim 2, wherein the light source portions are arranged parallel to an axis of the LED light bulb structure.

4. The LED light bulb structure of claim 3, wherein the light source portions are arranged into a circle to form a substantially triangular prism structure.

5. The LED light bulb structure of claim 3, wherein the light source portions are arranged into a circle to form a substantially quadrilateral prism structure.

6. The LED light bulb structure of claim 2, wherein the light source portions are set to form an acute angle θ with respect to an axis of the LED light bulb structure, such that when the acute angle θ increases progressively, the light source portions tend to have an irradiating direction towards the top of the lamp cover progressively.

7. The LED light bulb structure of claim 2, wherein the light source portions are set to form an acute angle θ with respect to an axis of the LED light bulb structure, such that when the acute angle θ of a portion of the light source portions increases progressively, the portion of the light source portions tend to have an irradiating direction towards the top of the lamp cover progressively, and when the acute angle θ of the other portion of the light source portions increases progressively, the portion of the light source portions have an irradiating direction towards the lamp holder progressively.

8. The LED light bulb structure of claim 1, further comprising at least one second LED installed in the installation space and electrically coupled to the circuit board.

9. The LED light bulb structure of claim 2, further comprising at least one second LED installed in the installation space and electrically coupled to the circuit board.

10. The LED light bulb structure of claim 3, further comprising at least one second LED installed in the installation space and electrically coupled to the circuit board.

11. The LED light bulb structure of claim 4, further comprising at least one second LED installed in the installation space and electrically coupled to the circuit board.

12. The LED light bulb structure of claim 5, further comprising at least one second LED installed in the installation space and electrically coupled to the circuit board.

13. The LED light bulb structure of claim 6, further comprising at least one second LED installed in the installation space and electrically coupled to the circuit board.

14. The LED light bulb structure of claim 7, further comprising at least one second LED installed in the installation space and electrically coupled to the circuit board.

15. The LED light bulb structure of claim 8, wherein the second LED is a top view LED having an irradiating direction towards the top of the lamp cover.

16. The LED light bulb structure of claim 1, wherein the first LED includes three pins, and one of the pins is electrically coupled to the other two pins, for carrying the chip to dissipate heat released from the chip.
